(19) United States
(12) Patent Application Publication
(10) Pub. No.: US 2023/0024657 A1
(43) Pub. Date: Jan. 26, 2023

(54) CONTROLLER FOR VIRTUAL ARMORED VEHICLES

(71) Applicant: Denis Viktorovich PAVLENKO, Ekaterinburg (RU)

(72) Inventors: Denis Viktorovich PAVLENKO, Ekaterinburg (RU); Ilya Vladimirovich KUZNETSOV, Uray, KHMAO-Yugra, Tyumenskaya obl. (RU); Eduard Ayratovich MINIAKHMETOV, Uray, KHMAO-Yugra, Tyumenskaya obl. (RU)

(21) Appl. No.: 17/788,645

(22) PCT Filed: Jun. 26, 2020
(86) PCT No.: PCT/RU2020/000309

§ 371 Date: Jun. 23, 2022

(30) Foreign Application Priority Data
Dec. 23, 2019 (RU) 2019143150

(51) Int. Cl. A63F 13/245; G09B 9/04

(52) U.S. Cl. CPC A63F 13/245; G09B 9/04

(57) ABSTRACT

A controller for virtual armored vehicles comprising fixed base with a pivot, a housing associated with the fixed base by a rotary mechanism located on the pivot of the fixed base and allowing the housing to rotate relative to the fixed base, right and left handles connected by a common shaft passing through the housing and having its own independent rotary mechanism permitting inclination of the handles, the rotary mechanism of the housing and the independent rotary mechanism of the shaft are provided with mechanisms for returning the housing and the shaft to the central positions in the absence of pressure from the user, rotation sensors of the housing and the common shaft with the handles, microcontroller functionally connected to the rotation sensors, means for communication of the microcontroller to a host device, and a power source.

### FIELD OF INVENTION

The present invention relates to peripheral input/output devices for controlling virtual vehicles, in particular to gaming or training controllers for virtual armored vehicles.

### BACKGROUND OF INVENTION

Different controllers for virtual aircraft and automotive wheeled vehicles are known from the current level of technology. These controllers are not originally designed to control virtual armored vehicles and their guns.

A computer keyboard and a computer mouse, either separately or in combination, can be used as a game controller. However, controlling virtual vehicles by these controllers raises certain difficulties and inconveniences, since these devices were originally designed for other purposes, and controlling virtual vehicles by the computer keyboard and the computer mouse is inconvenient and limits the user's capabilities, accuracy and response speed.

There are simple control devices for virtual vehicles, such as gamepads and joysticks, i.e. controllers used in flight simulators, and rudders with pedals, i.e. controllers used in car simulators. However, these devices are also specialized to a certain extent, and their use as game controllers for controlling virtual armored vehicles also entails certain inconveniences and control difficulties, accuracy of gun guidance and reaction speed.

Controllers and control knobs of military equipment simulators, for example, devices of the AFV Sim company (https://www.afvsim.com/Product/) are known. However, these devices are intended for training mechanic-drivers and shooters of combat units. Thus, they are highly specialized for each specific model of armored vehicles, and they have limited functionality.

### BRIEF DESCRIPTION OF THE PRESENT INVENTION

The goal of the present invention is to provide a user with a convenient controller for virtual armored vehicles, and mainly to provide a convenient means for guiding guns of the virtual armored vehicles and tracking virtual targets.

The specified goal is achieved by creating a controller of the present invention. The present invention is a controller for virtual armored vehicles comprising fixed base with a pivot, a housing associated with the fixed base by means of a rotary mechanism located on the pivot of the fixed base and allowing the housing to rotate relative to the fixed base, right and left handles connected by a common shaft passing through the housing and having its own independent rotary mechanism allowing to incline these handles, wherein the rotary mechanism of the housing and the independent rotary mechanism of the shaft provided with mechanisms for returning the housing and the shaft to the central positions in the absence of pressure made by the user, rotation sensors or encoders of the pivot and the common shaft with the handles, microcontroller functionally connected to rotary sensors or encoders, means for communication of the microcontroller to a host device, and power source.

The technical effect provided by the given aggregate features is the increased comfort during prolonged use of the controller due to two-hand control, more accurate aiming due to the independent operation of two axes, the ability to smoothly track a virtual target by controlling the speed of rotation, but not the absolute position of the sight of the virtual gun.

In another aspect of the present invention, magnetic and magnetoresistive sensors, including encoders and potentiometers, and opto encoders are used as sensors of rotation of the housing and the common shaft.

In another aspect of the present invention, the controller disclosed above additionally comprises a private circuit to the analog section of the controller based on a reference voltage source.

In another aspect of the present invention, the housing and mechanical details of the controller are completely made of metal.

In another aspect of the present invention, all moving mechanical parts of the controller are equipped with bearings or anti-friction bushings, or contain lubricants.

In another aspect of the present invention, the housing of the controller is equipped with input and output devices with assignable functions.

In another aspect of the present invention, the input and output devices include buttons, toggle switches, switches, displays, touch panels and LEDs.

In another aspect of the present invention, the host device is selected from a computer, a game console, a tablet or a smartphone.

In another aspect of the present invention, the microcontroller is connected to the host device by a data exchange protocol selected from USB protocol, FireWare protocol, Thunderbolt protocol, TCP-IP protocol, Bluetooth protocol, or Wi-Fi protocol.

The present invention is explained in more detail below with reference to the drawings, provided for illustrative purposes only and not limiting the scope of the present invention.

### BRIEF DESCRIPTION OF DRAWINGS

FIGS. 1, 2 and 3 depicts a schematic view of the controller of the present invention, i.e. front view, top view and side view, respectively. The following notations are used: 1 and 2—right and left handles, respectively; 3—the fixed base; 4—the rotary mechanism; 5—common shaft with handles fixed on it; 6—housing.

FIGS. 4, 5 and 6 depicts front view, top view and side view, respectively, of mechanical components of the controller of the present invention without housing, comprising fixed base with the pivot, the shaft with handles and rotary mechanisms, including mechanisms for returning the housing and the shaft to the central positions, as well as sensors of rotation of the housing and the shaft in the embodiment of the present invention comprising magnetoresistive rotation sensors. The following notations are used: 1 and 2—right and left handles, respectively; 3—the fixed base; 5—common shaft with handles fixed on it; 7—the pivot of the fixed base, on which the housing of the controller rotates; 8—sensors; 9—magnets.

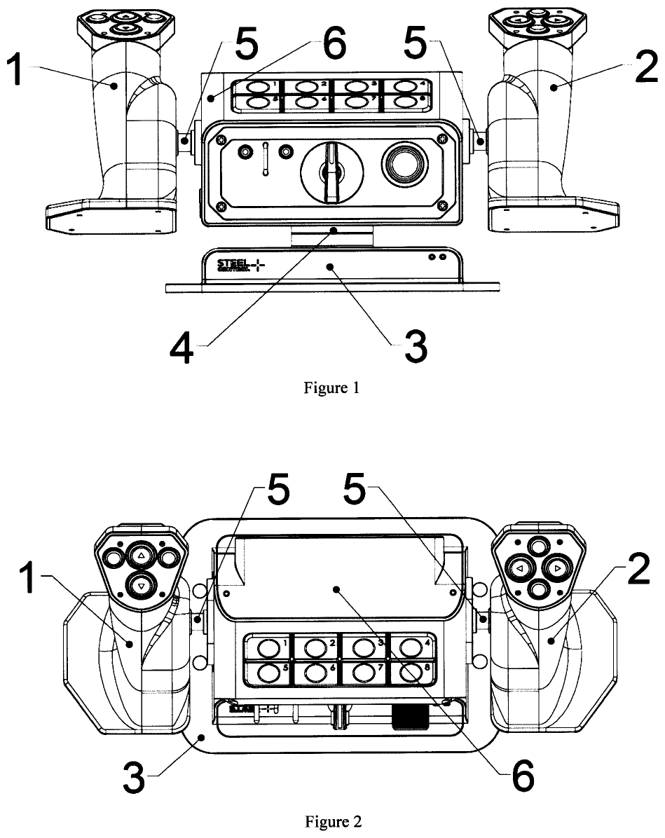

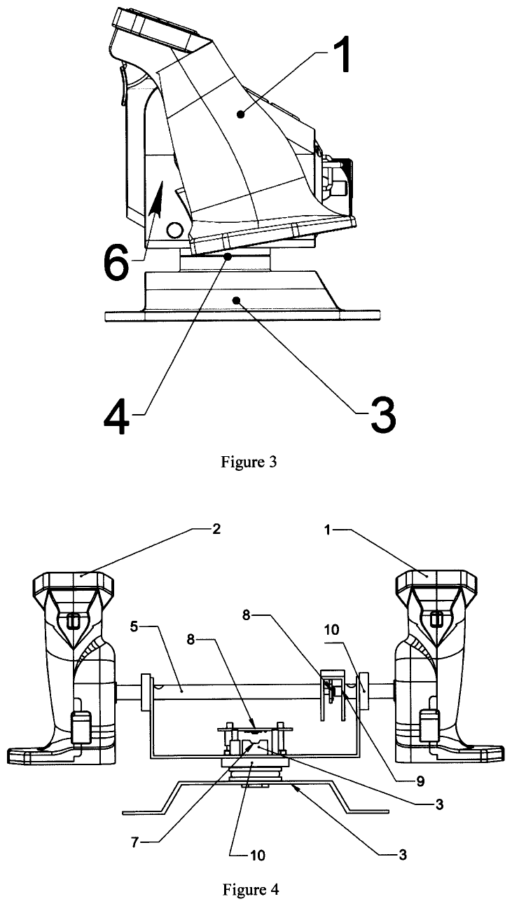

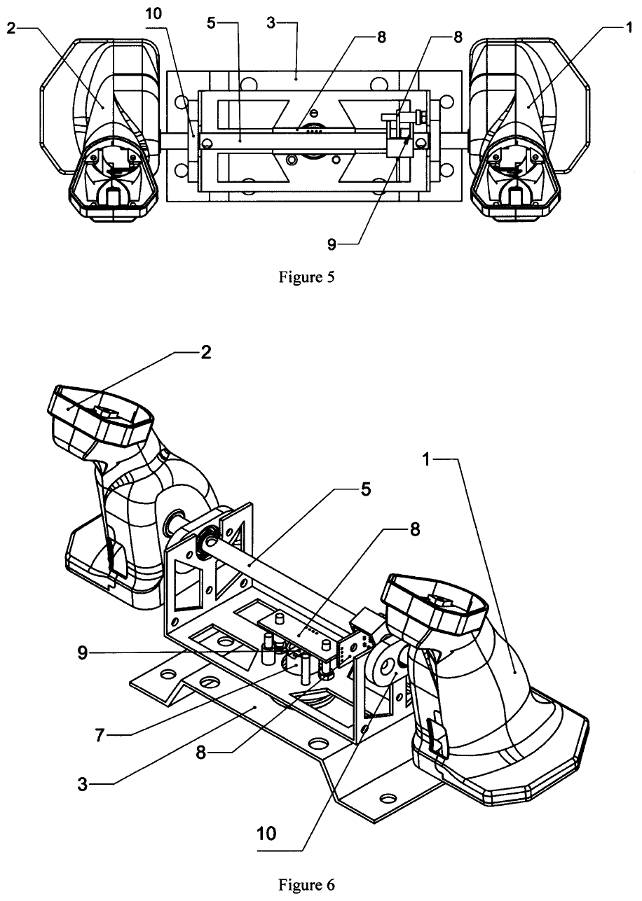

### DETAILED DESCRIPTION OF THE PRESENT INVENTION

Controller of the present invention comprises fixed base with a pivot and a housing associated with the fixed base by means of a rotary mechanism located on the pivot of the fixed base, as well as right and left handles connected by a common shaft passing through the housing and having its own independent rotary mechanism. Further, the rotary mechanism of the housing and the independent rotary mechanism of the shaft are provided with mechanisms for returning the housing and the shaft to the central positions in the absence of pressure made by the user. The housing of the controller has the ability to rotate left and right, the handles have the ability to rotate forward and backward, mechanisms for returning the housing and the shaft return the housing and handles to the central position.

Control of the gun of the virtual armored vehicle and the virtual armored vehicle itself with two hands, as well as presence of the reverse pressure made by the mechanisms for returning the housing and the shaft to the central position when a pressure shifting the housing and the shaft from the central position is applied, allows the user to control the virtual armored vehicle's gun, as well as the virtual armored vehicle itself, easily and smoothly. It also allows the user to point the gun at the virtual target precisely and accurately, and to dwell it. Thus, high efficiency of virtual battle and defeat of targets is achieved.

To take readings from the rotation axes, the controller uses rotation sensors. As rotation sensors, various angle sensors can be used, including magnetic and magnetoresistive sensors, potentiometers, opto encoders and other types of sensors known to those skilled in the art. It is preferable to use magnetoresistive sensors in conjunction with radial magnetization magnets. The sensor and magnet are coaxial, one of the elements being located on the housing, and the second on one of the moving axes. Using an engineering solution of this type allows to completely get rid of mechanical wear and makes the control process silent and comfortable. It is preferable to use a rotation sensor that combines a sensor and an operational amplifier in a single housing.

By use of the system where the horizontal and the vertical rotation speed of the gun corresponds to the angle of rotation of the housing of the controller and the shaft with the handles, respectively, the controller of the present invention allows to dwell the virtual target as on a real vehicle. Customizable sensitivity curves and the ability to switch them directly in battle allow user to destroy enemy virtual armored vehicles in any conditions with high efficiency.

Controller of the present invention also comprises a microcontroller, preferably high performance microcontroller. Information about the angle of rotation of the housing of the controller and the shaft with the handles is transmitted to the microcontroller and converted either by the microcontroller itself or by means of the host device software into the horizontal and vertical speed of rotation of the gun, respectively. Preferably, the microcontroller has FPU support. It allows user to achieve high pointing accuracy of the gun with minimal delays.

The controller of the present invention is equipped with additional controlling elements with assignable functions, i.e. input and output devices, allowing the user to play the role of any crew member of the vehicle from one device. The input and output devices are located at the housing of the controller and at the handles. The input and output devices includes include buttons, toggle switches, switches, displays, touch panels and LEDs.

Also, the flexible model of dynamically loaded settings and the functionality of the controller of the present invention allows the user to apply the controller on a variety of platforms and in a variety of games. The controller of the present invention also may be used as a controller in training simulators for shooters of real armored vehicles. In other words, the controller of the present invention is a universal device suitable for use in various systems and configurations.

The power circuits of the various device systems are isolated from each other. Use of a private circuit to the analog section of the device based on a reference voltage source is preferable in order to provide precise operation of the controller with any host device.

The housing and mechanical details of the controller may be made of a suitable plastic or of a metal. Implementation of mechanical parts made of a metal is preferred. The most preferable is implementation of the controller to with the housing and mechanical details of the controller completely made of metal.

In order to provide easy and smooth running, all moving mechanical parts of the controller are equipped with bearings or anti-friction bushings, or contain lubricants.

A computer, either personal computer or simulator computer, a game console, a tablet or a smartphone may be used as a host device.

Communication of the microcontroller to the host device is carried out by wires or by wireless method. Communication of the microcontroller to the host device by a data exchange protocol selected from USB protocol, FireWare protocol, Thunderbolt protocol, TCP-IP protocol, Bluetooth protocol, or Wi-Fi protocol is preferable.

Controller of the present invention works as follows: the device is installed on the surface of the table and connected to the host device by wires or using wireless technology. The necessary software runs on the host device. If necessary, the user assigns functions to all or some of the input and output devices (buttons, toggle switches, switches) necessary for use in various virtual armored vehicles control modes (gunner mode, driver mode, etc.).

In gunner mode, the user places his hands on handles (1, 2) of the controller. If horizontal pointing of the virtual gun is necessary, the user holding the handles (1, 2) rotates the housing (6) relative to the base (3) around the pivot (4) by the angle necessary in this situation. If the vertical pointing of the virtual gun is necessary, the user inclines the handles (1, 2) around the axis of the shaft (5). As soon as the need for horizontal and/or vertical pointing of the sight of the virtual gun disappears, the user releases the handles (1, 2) and the mechanisms for returning the housing and the shaft independently return the device to the central, original position.

Although the present invention has been described in detail with reference to preferred embodiments, it is clear to a person skilled in the art that various substitutions can be made and various equivalents can be used that are not outside the scope of the present invention defined by the following claims.

1. A controller for virtual armored vehicles comprising:
a fixed base with a pivot,
a housing associated with the fixed base by means of a rotary mechanism located on the pivot of the fixed base and allowing the housing to rotate relative to the fixed base,
right and left handles connected by a common shaft passing through the housing and having its own independent rotary mechanism allowing to incline these handles,
wherein the rotary mechanism of the housing and the independent rotary mechanism of the shaft are provided with mechanisms for returning the housing and the shaft to the central positions in the absence of pressure made by the user,
sensors of rotation of the housing and the common shaft with the handles,
a microcontroller functionally connected to the rotation sensors,
a means for communication of the microcontroller to a host device, and
a power source.

2. The controller according to claim 1, wherein sensors of rotation of the housing and the common shaft with the handles are selected from magnetic and magnetoresistive sensors, including encoders and potentiometers, and opto encoders.

3. The controller according to claim 1, additionally comprising a private circuit to the analog section of the controller based on a reference voltage source.

4. The controller according to claim 1, wherein the housing and mechanical details of the controller are made of a plastic or a metal.

5. The controller according to claim 1, wherein all moving mechanical parts are equipped with bearings or anti-friction bushings, or contain lubricants.

6. The controller according to claim 1, wherein the housing and the handles are equipped the input and output devices with assignable functions.

7. The controller according to claim 6, wherein the input and output devices are selected from buttons, toggle switches, switches, displays, touch panels and LEDs.

8. The controller according to claim 1, wherein the host device is selected from a computer, a game console, a tablet or a smartphone.

9. The controller according to claim 1, therein the microcontroller is connected to the host device by a data exchange protocol selected from USB protocol, FireWare protocol, Thunderbolt protocol, TCP-IP protocol, Bluetooth protocol, or Wi-Fi protocol.
